(19) United States
(12) Patent Application Publication
(10) Pub. No.: US 2015/0284520 A1
(43) Pub. Date: Oct. 8, 2015

(54) METHACRYLIC RESIN COMPOSITION

(71) Applicant: KURARAY CO., LTD., Kurashiki-shi, Okayama (JP)

(72) Inventors: Hiroshi Ozawa, Tainai-shi (JP); Takuro Niimura, Tainai-shi (JP); Atsushi Matsumura, Tainai-shi (JP); Atsuhiro Nakahara, Tainai-shi (JP)

(73) Assignee: KURARAY CO., LTD., Kurashiki-shi, Okayama (JP)

(21) Appl. No.: 14/441,585

(22) PCT Filed: Nov. 8, 2013
(86) PCT No.: PCT/JP2013/006604

§ 371 Date: May 8, 2015

(30) Foreign Application Priority Data
Nov. 9, 2012 (JP) 2012-247933

(51) Int. Cl. C08J 5/00; C08F 220/10

(52) U.S. Cl. CPC C08J 5/00; C08F 220/10; C08J 2333/12

(57) ABSTRACT

A methacrylic resin composition, comprising a methacrylic resin which comprises 50-90% by mass of a structural unit derived from methyl methacrylate and 10-50% by mass of a structural unit derived from methacrylic acid alicyclic hydrocarbon ester, wherein the difference between the yellow index (YI4) at an optical path length of 200 mm for an injection molded article obtained at a cylinder temperature of 280° C. and a molding cycle of 4 minutes and the yellow index (YI1) at an optical path length of 200 mm for an injection molded article obtained at a cylinder temperature of 280° C. and a molding cycle of 1 minute is 3 or less, and the melt flow rate at a temperature of 230° C. and under a load of 3.8 kg is 5 g/10 min or more.

### TECHNICAL FIELD

The present invention relates to a methacrylic resin composition. More particularly, the present invention relates to a methacrylic resin composition which enables obtaining a shaped article having a thin wall and large area with less coloration, high transparency, low haze, high impact strength, low saturated water absorption, small dimensional change and good appearance with high production efficiency.

### BACKGROUND ART

A methacrylic resin has excellent transparency, light resistance, surface hardness and the like. It is possible to obtain various optical components such as light guide plates, lens and the like by molding a methacrylic resin composition comprising the methacrylic resin.

In recent years, there is much demand for a liquid crystal display device with a lightweight and large area, and accordingly it is required to make an optical component thinner and of wide area. Furthermore, in association with improved image quality of the display device, high precision is required for optical properties such as refractive index, retardation or the like. However, the dimensional change associated with moisture absorption, heat or the like is increased by thinning and area-widening of the optical component. As a result, the optical properties of the optical component are likely to change. Therefore, it is strongly required for the methacrylic resin composition which is a raw material of the optical component to have high transparency, low moisture absorption, high heat resistance, small dimensional change, high impact strength, excellent formability and the like.

An optical resin material obtained by polymerizing a monomer comprising 5% by weight or more of tricyclodecanyl (meth)acrylate is known as the resin material for the optical component, for example (see, Patent Document 1). However, this optical resin material is easy to be colored on molding at a high molding temperature. Therefore, for this optical resin material, injection molding is carried out at a relatively low temperature of 230 to 260° C. In the low temperature injection molding, it is difficult to obtain an optical component with high precision since the productivity of the shaped article is low, and the resulting shaped article has residual stress and is susceptible to dimensional change due to heat.

### CITATION LIST

### Patent Literature

Patent Document 1: JP S61-73705 A

### Non-Patent Literature

Non-Patent Document 1: “Hydrogen abstraction ability of organic peroxide and initiator efficiency”, Nippon Oil & Fats Co., Ltd. Technical Data (created on April 2003)

### SUMMARY OF THE INVENTION

### Problems to be Resolved by the Invention

In view of the above problems, an object of the present invention is to provide a methacrylic resin composition which enables obtaining a shaped article having a thin wall and large area with less-coloration, high transparency, low haze, low saturated water absorption, small dimensional change and good appearance with high production efficiency.

### Means for Solving the Problems

As a result of earnest investigation, the inventors have completed the present invention including the following embodiments.

(1) A methacrylic resin composition, comprising a methacrylic resin which comprises 50 to 90% by mass of a structural unit derived from methyl methacrylate and 10 to 50% by mass of a structural unit derived from methacrylic acid alicyclic hydrocarbon ester,

wherein the difference between the yellow index (YI4) at an optical path length of 200 mm for an injection molded article obtained at a cylinder temperature of 280° C. and a molding cycle of 4 minutes and the yellow index (YI1) at an optical path length of 200 mm for an injection molded article obtained at a cylinder temperature of 280° C. and a molding cycle of 1 minute is 3 or less, and

the melt flow rate at a temperature of 230° C. and under a load of 3.8 kg is 5 g/10 min or more.

(2) The methacrylic resin composition according to (1), wherein the methacrylic acid alicyclic hydrocarbon ester is dicyclopentanyl methacrylate.
(3) The methacrylic resin composition according to (1) or (2), wherein the saturated water absorption is 1.6 by mass or less.
(4) A method for producing the methacrylic resin composition according to any one of (1) to (3), the method comprising a step of continuous bulk polymerization of a monomer mixture comprising the methyl methacrylate and the methacrylic acid alicyclic hydrocarbon ester.
(5) A shaped article composed of the methacrylic resin composition according to any one of (1) to (3).
(6) The shaped article according to (5), wherein the ratio of the resin flow length to the thickness is 380 or more.

### Advantageous Effects of the Invention

The methacrylic resin composition of the present invention makes it possible to obtain a shaped article having a thin wall and large area with less coloration, high transparency, low haze, low saturated water absorption, small dimensional change and good appearance with high production efficiency. An injection molded article having a thin wall and large area with small residual strain and little coloration can be obtained with high production efficiency by using the methacrylic resin composition of the present invention.

### BRIEF DESCRIPTION OF THE DRAWINGS

FIG. 1 a figure showing the resin flow length in an injection mold.

### EMBODIMENTS FOR CARRYING OUT THE INVENTION

The methacrylic resin composition of the present invention comprises a methacrylic resin. The amount of the methacrylic resin comprised in the methacrylic resin composition of the present invention is preferably 97% by mass or more, more preferably 98% by mass or more and even more preferably 99% by mass or more based on the total amount of the methacrylic resin composition.

In the methacrylic resin used in the present invention, the content of the structural unit derived from methyl methacrylate is 50 to 90% by mass, preferably 65 to 89% by mass and more preferably 75 to 88% by mass, and the content of the structural unit derived from methacrylic acid alicyclic hydrocarbon ester is 10 to 50% by mass, preferably 11 to 35% by mass and more preferably 12 to 25% by mass.

Examples of the methacrylic acid alicyclic hydrocarbon ester include methacrylic acid monocyclic aliphatic hydrocarbon ester such as cyclohexyl methacrylate, cyclopentyl methacrylate, cycloheptyl methacrylate; methacrylic acid polycyclic aliphatic hydrocarbon ester such as 2-norbornyl methacrylate, 2-methyl-2-norbornyl methacrylate, 2-ethyl-2-norbornyl methacrylate, 2-isobornyl methacrylate, 2-methyl-2-isobornyl methacrylate, 2-ethyl-2-isobornyl methacrylate, 8-tricyclo[5.2.1.0^{2,6}]decanyl methacrylate, 8-methyl-8-tricyclo[5.2.1.0^{2,6}]decanyl methacrylate, 8-ethyl-8-tricyclo[5.2.1.0^{2,6}]decanyl methacrylate, 2-adamantyl methacrylate, 2-methyl-2-adamantyl methacrylate, 2-ethyl-2-adamantyl methacrylate, 1-adamantyl methacrylate, 2-fenchyl methacrylate, 2-methyl-2-fenchyl methacrylate, 2-ethyl-2-fenchyl methacrylate. Among these, methacrylic acid polycyclic aliphatic hydrocarbon ester is preferred, and tricyclo[5.2.1.0^{2,6}]decanyl methacrylate (alias: dicyclopentanyl methacrylate) is more preferred.

The methacrylic resin used in the present invention may comprise a structural unit derived from other monomers than those derived from methyl methacrylate and methacrylic acid alicyclic hydrocarbon ester, without compromising the advantages of the present invention. Examples of these other monomers include acrylic ester such as methyl acrylate, ethyl acrylate, n-propyl acrylate, isopropyl acrylate, n-butyl acrylate, isobutyl acrylate, s-butyl acrylate, t-butyl acrylate, amyl acrylate, isoamyl acrylate, n-hexyl acrylate, 2-ethylhexyl acrylate, pentadecyl acrylate, dodecyl acrylate, cyclohexyl acrylate, norbornenyl acrylate, isobonyl acrylate, benzyl acrylate, phenoxyethyl acrylate, 2-hydroxyethyl acrylate, 2-ethoxyethyl acrylate, glycidyl acrylate, allyl acrylate, phenyl acrylate; methacrylic acid alkyl ester other than methyl methacrylate such as ethyl methacrylate, n-propyl methacrylate, isopropyl methacrylate, n-butyl methacrylate, isobutyl methacrylate, s-butyl methacrylate, t-butyl methacrylate, amyl methacrylate, isoamyl methacrylate, n-hexyl methacrylate, 2-ethylhexyl methacrylate, pentadecyl methacrylate, dodecyl methacrylate, phenyl methacrylate; unsaturated carboxylic acid such as acrylic acid, methacrylic acid, maleic anhydride, maleic acid, itaconic acid; olefin such as ethylene, propylene, 1-butene, isobutylene, 1-octene; conjugated diene such as butadiene, isoprene, myrcene; aromatic vinyl compound such as styrene, α-methylstyrene, p-methylstyrene, m-methylstyrene; acrylamide, methacrylamide, acrylonitrile, methacrylonitrile, vinyl acetate, vinyl pyridine, vinyl ketone, vinyl chloride, vinylidene chloride, vinylidene fluoride and the like. The content of the structural unit derived from these other monomers is preferably 10% by mass or less and more preferably 5% by mass or less.

The methacrylic resin used in the present invention has a glass transition temperature of preferably 100 to 140° C., more preferably 105 to 135° C. and even more preferably 110 to 130° C. A low glass transition temperature tends to decrease the heat resistance and the like. A high glass transition temperature tends to decrease the formability and the like.

The methacrylic resin used in the present invention has a weight-average molecular weight of preferably 35,000 to 100,000, more preferably 40,000 to 90,000, even more preferably 45,000 to 80,000 and most preferably 60,000 to 80,000. When the weight-average molecular weight is smaller than 35,000, a shaped article composed of the methacrylic resin composition tends to have insufficient impact resistance and toughness, while the weight-average molecular weight is larger than 100,000, the formability of the methacrylic resin composition tends to be insufficient.

The methacrylic resin used in the present invention has the ratio of a weight-average molecular weight to a number-average molecular weight (weight-average molecular weight/number-average molecular weight: hereinafter, this ratio may be sometimes referred to as a molecular weight distribution) of preferably from 1.7 to 2.6, more preferably from 1.7 to 2.3 and particularly preferably from 1.7 to 2.0. A small molecular weight distribution of the methacrylic resin tends to decrease the formability of the methacrylic resin composition. A large molecular weight distribution tends to decrease the impact resistance of the shaped article obtained from the resin composition and make it brittle.

Note that the weight-average molecular weight and the number-average molecular weight are the molecular weights in terms of standard polystyrene measured by GPC (gel permeation chromatography).

The weight-average molecular weight, the number-average molecular weight and the molecular weight distribution of the methacrylic resin can be controlled by adjusting the kind and amount of the polymerization initiator and the chain transfer agent described below.

Such a methacrylic resin is obtained by polymerizing a monomer mixture comprising methyl methacrylate and methacrylic acid alicyclic hydrocarbon ester, and optionally other monomers.

The yellow index of methyl methacrylate, and methacrylic acid alicyclic hydrocarbon ester and optionally other monomers as raw materials of the methacrylic resin is preferably not more than 2 and more preferably not more than 1. If the yellow index of the monomers is small, a shaped article with little coloration can be easily obtained with high production efficiency, when the resulting methacrylic resin composition is formed. The yellow index is the value of yellowness calculated in accordance with JIS K7373 based on the value measured by using the color-difference colorimeter ZE-2000 manufactured by Nippon Denshoku Industries Co., Ltd., in accordance with JIS 28722.

In the production of the methacrylic resin used in the present invention, polymerization is preferably carried out by bulk polymerization method or solution polymerization method, more preferably bulk polymerization method. In addition, polymerization is preferably carried out by continuous bulk polymerization method from the point of view of the productivity. The polymerization reaction is initiated by adding a polymerization initiator to the monomer mixture at a predetermined temperature. Further, the weight-average molecular weight, the number-average molecular weight and the molecular weight distribution of the resulting methacrylic resin can be controlled by adding a chain transfer agent to the monomer mixture, if necessary.

The dissolved oxygen content of the monomer mixture described above is preferably 10 ppm or less, more preferably 5 ppm or less, even more preferably 4 ppm or less and particularly preferably 3 ppm or less. In such a range of the dissolved oxygen content, polymerization reaction proceeds smoothly and a shaped article without silver streak or coloration can be easily obtained.

The polymerization initiator used in the production of the methacrylic resin is not particularly limited as long as it generates reactive radicals. Examples of the polymerization initiator include t-hexyl peroxyisopropylmonocarbonate, t-hexyl peroxy 2-ethylhexanoate, 1,1,3,3-tetramethylbutyl peroxy 2-ethylhexanoate, t-butyl peroxy pivalate, t-hexyl peroxy pivlate, t-butyl peroxy neodecanoate, t-hexyl peroxy neodecanoate, 1,1,3,3-tetramethylbutyl peroxy neodecanoate, 1,1-bis(t-hexyl peroxy) cyclohexane, benzoyl peroxide, 3,5,5-trimethylhexanoyl peroxide, lauroyl peroxide, 2,2′-azobis(2-methyl propionitrile), 2,2′-azobis(2-methyl butyronitrile), dimethyl 2,2′-azobis(2-methyl propionate) and the like. Among these, t-hexyl peroxy 2-ethylhexanoate, 1,1-bis(t-hexyl peroxy) cyclohexane, dimethyl 2,2′-azobis(2-methyl propionate) are preferred.

The polymerization initiator has a 1 hour half-life temperature of preferably 60 to 140° C., more preferably 80 to 120° C. When the polymerization reaction is carried out by bulk polymerization method, the hydrogen abstraction ability of the polymerization initiator is preferably 20% or less, more preferably 10% or less and even more preferably 5% or less.

These polymerization initiators may be used alone or in combination of two or more.

In addition, the amount or addition method of the polymerization initiator to be added may be set appropriately according to the purpose and are not particularly limited. For example, the amount of the polymerization initiator used in bulk polymerization is preferably 0.0001 to 0.02 part by mass and more preferably 0.001 to 0.01 part by mass with respect to 100 parts by mass of the monomer mixture.

The hydrogen abstraction ability can be known from technical data of polymerization initiator manufacturers (for example, Non-Patent Document 1) and the like. Further, it can be determined by radical trapping method using α-methylstyrene dimer, that is, α-methylstyrene dimer trapping method. The measurement is generally performed as follows. First, a polymerization initiator is cleaved in the coexistence of α-methylstyrene dimer as a radical trapping agent and cyclohexane to produce radical fragments. Of the radical fragments generated, those with low hydrogen abstraction ability are captured by addition to double bonds of α-methylstyrene dimer. On the other hand, radical fragments with high hydrogen abstraction ability abstract hydrogens from cyclohexane to produce cyclohexyl radicals, which are captured by addition to double bonds of α-methylstyrene dimer to produce a cyclohexane trapping product. Therefore, the ratio of the radical fragments with high hydrogen abstraction ability to the theoretical radical fragments generation amount (molar fraction), which can be determined by quantifying cyclohexane or cyclohexane trapping product, is defined to be hydrogen abstraction ability.

The chain transfer agent includes alkyl mercaptan such as n-octyl mercaptan, n-dodecyl mercaptan, t-dodecyl mercaptan, 1,4-butanedithiol, 1,6-hexanedithiol, ethylene glycol bisthiopropionate, butanediol bisthioglycolate, butanediol bisthiopropionate, hexanediol bisthioglycolate, hexanediol bisthiopropionate, trimethylolpropane tris(β-thiopropionate), pentaerythritol tetrakisthiopropionate; α-methylstyrene dimer; terpinolene and the like. Among these, monofunctional alkyl mercaptan such as n-octyl mercaptan, n-dodecyl mercaptan and the like is preferred. These chain transfer agents may be used alone or in combination of two or more. The amount of the chain transfer agent used is preferably 0.1 to 1 part by mass, more preferably 0.2 to 0.8 part by mass and even more preferably 0.3 to 0.6 part by mass with respect to 100 parts by mass of the monomer mixture.

A solvent which can be used in solution polymerization method is not particularly limited as long as it has the dissolution ability for the monomer mixture and the product methacrylic resin, but aromatic hydrocarbons such as benzene, toluene and ethyl benzene are preferred. These solvents may be used alone or in combination of two or more. The amount of the solvents used is preferably 0 to 100 parts by mass and more preferably 0 to 90 parts by mass with respect to 100 parts by mass of the monomer mixture. If the amount of the solvent used is larger, the viscosity of the reaction solution decreases and the handling property becomes good, but the productivity tends to decrease.

In the production of the methacrylic resin, polymerization is preferably carried out in a continuous flow reactor though it can be carried out in a batch reactor. The continuous flow reactor is a device for feeding reaction raw materials to the reactor at a constant flow rate, discharging a solution comprising the reaction product obtained in the reactor at a constant flow rate, balancing feeding of the reaction raw materials and discharging of the solution comprising the reaction product so as to advance the reaction continuously. Typical examples of reactors used in the continuous flow reactor include a continuous flow tank reactor and a plug flow reactor. For example, in order to obtain the methacrylic resin used in the present invention, the initial stage to the middle stage of the reaction can be carried out in a complete mixing reactor, and the final stage of the reaction can be carried out in a plug flow reactor. One or more reactors may be used, or two or more different reactors may be used in combination. The reactor may have a stirrer, which can be selected according to the mode of the reactor. Examples of the stirrer include a Maxblend stirrer, a stirrer with lattice-shaped wings rotating around a vertical axis arranged in the center, a propeller stirrer, a screw stirrer and the like, and among these, a Mexblend stirrer is preferred from the viewpoint of uniform mixing.

A device particularly suitable for the production of the methacrylic resin used in the present invention is one that having at least one continuous flow tank reactor. A plurality of continuous flow tank reactors may be connected in series or in parallel. When a continuous flow tank reactor is used, the fluid volume in the reaction tank is set to be almost constant by balancing the feeding amount to the reaction tank and the discharging amount from the reaction tank. The fluid volume in the reaction tank is preferably from ¼ to ¾ and more preferably from ⅓ to ⅔ of the volume of the reaction tank.

A monomer, a polymerization initiator and a chain transfer agent used in the production of the methacrylic resin may be mixed before feeding all of them to the reaction tank and then fed to the reaction tank, or they may be fed to the reaction tank separately. In the present invention, a method in which all of them are mixed before feeding them to the reaction tank and then fed to the reaction tank is preferred.

Mixing of a monomer, a polymerization initiator and a chain transfer agent is preferably performed in an inert atmosphere such as nitrogen gas. In addition, in order to perform the operation of the continuous flow reaction smoothly, it is preferred that each of methyl methacrylate, methacrylic acid alicyclic hydrocarbon ester, a polymerization initiator and a chain transfer agent is fed continuously to a mixer provided in the stage prior to the reaction tank via each tube from a tank storing them and mixed in the mixer, and the mixture is flowed continuously into the reaction tank. The mixer is preferably equipped with a stirrer.

The temperature of the polymerization reaction is preferably 100 to 160° C. and more preferably 110 to 150° C. The temperature of the polymerization reaction in such a range makes it easy to adjust the difference between YI4 and YI1 and the melt flow rate in the range described below.

The polymerization reaction time is preferably 0.5 to 4 hours and more preferably 1 to 3 hours. In the case of a continuous flow tank reactor, the polymerization reaction time is the average residence time in the reactor. Too short polymerization reaction time increases the amount of the polymerization initiator required. Further, increased amount of the polymerization initiator tends to make it difficult to control the polymerization reaction and the molecular weight. On the other hand, too long polymerization reaction time tends to need time for the reaction to be the steady state and decrease the productivity. In addition, the polymerization is preferably carried out in an inert atmosphere such as nitrogen gas.

The polymerization conversion ratio of the monomer mixture is preferably 20 to 80% by mass, more preferably 30 to 70% by mass and even more preferably 35 to 65% by mass. The polymerization conversion ratio in such a range makes it easy to adjust the difference between YI4 and YI1 in a preferable range. Too high polymerization conversion ratio tends to require large agitation power due to the increased viscosity. Too low polymerization conversion ratio tends to lead to insufficient devolatizing and when molding the methacrylic resin composition obtained, the shaped article tends to have poor appearance such as silver streak.

After completion of the polymerization, if necessary, unreacted monomers and solvents are removed. A method for removing is not particularly limited but heating devolatizing is preferred. Examples of the devolatizing methods include equilibrium flash method and adiabatic flush method. In the adiabatic flush method, particularly, devolatizing is performed at a temperature of preferably 200 to 300° C. and more preferably 220 to 270° C. The temperature below 200° C. needs time for devolatizing and devolatizing is likely to be insufficient. When devolatizing is insufficient, the shaped article may have poor appearance such as silver streak. Conversely, the temperature above 300° C. tends to lead to coloring of the methacrylic resin composition due to oxidation, burning and the like.

The methacrylic resin composition of the present invention may contain other various additives, if necessary. The content of each of the additives is preferably 1 g by mass or less, more preferably 0.5% by mass or less and even more preferably 0.3% by mass or less. Too much content of the additives may cause poor appearance such as silver streak in the shaped article.

Examples of the additives include heat stabilizers, antioxidants, thermal deterioration inhibitors, UV absorbers, light stabilizers, lubricants, mold release agents, inorganic fillers, inorganic or organic fibers, mineral oil softeners, polymer processing aids, antistatic agents, flame retardants, dyes and pigments, coloring agents, delusterants, light diffusion agents, impact resistance modifiers, fluorescent substances, adhesives, tackifiers, plasticizers, foaming agents and the like.

Antioxidants are those having an effect of preventing oxidation degradation in the presence of oxygen. They include for example, phosphorus antioxidants, hindered phenol antioxidants, thioether antioxidants and the like. These antioxidants may be used alone or in combination of two or more. Among these, from the viewpoint of the effect of preventing deterioration of optical properties due to coloration, phosphorus antioxidants and hindered phenol antioxidants are preferred, and combined use of phosphorus antioxidants and hindered phenol antioxidants is more preferred.

When phosphorus antioxidants and hindered phenol antioxidants are used in combination, the ratio is not particularly limited, but the mass ratio of the phosphorus antioxidants/hindered phenol antioxidants is preferably from 1/5 to 2/1 and more preferably from 1/2 to 1/1.

Examples of the phosphorus antioxidants include 2,2-methylenebis(4,6-di-t-butylphenyl) octyl phosphite (ADEKA Co., Ltd., trade name: ADK STAB HP-10), tris(2,4-di-t-butylphenyl) phosphite (Ciba Specialty Chemicals Inc, trade name: IRUGAFOS168), 3,9-bis(2,6-di-tert-butyl-4-methylphenoxy)-2,4,8,10-tetraoxa-3,9-diphosphaspiro[5.5]undecane (ADEKA Co., Ltd., trade name: ADK STAB PEP-36) and the like.

Examples of the hindered phenol antioxidants include pentaerythrityl-tetrakis[3-(3,5-di-t-butyl-4-hydroxyphenyl) propionate] (Ciba Specialty Chemicals Inc, trade name: IRGANOX1010), octadecyl-3-(3,5-di-t-butyl-4-hydroxyphenyl) propionate (Ciba Specialty Chemicals Inc, trade name: IRGANOX1076) and the like.

The thermal deterioration inhibitors are compounds which can prevent thermal deterioration of the resin by trapping polymer radicals generated when exposed to intense heat under a substantially oxygen-free condition. They include for example, 2-t-butyl-6-(3′-t-butyl-5′-methyl-hydroxybenzyl)-4-methylphenyl acrylate (Sumitomo Chemical Co., Ltd., trade name: SUMILIZER GM), 2,4-di-t-amyl-6-(3′,5′-di-t-amyl-2′-hydroxy-α-methylbenzyl) phenyl acrylate (Sumitomo Chemical Co., Ltd., trade name: SUMILIZER GS) and the like.

The UV absorbers are compounds having the ability to absorb ultraviolet rays. They include for example, benzophenones, benzotriazoles, triazines, benzoates, salicylates, cyanoacrylates, oxalic anilides, malonic esters, formamidines and the like. These may be used alone or in combination of two or more. Among these, benzotriazoles and anilides are preferred.

Examples of Benzotriazoles include 2-(2H-benzotriazole-2-yl)-4-(1,1,3,3-tetramethylbutyl) phenol (Ciba Specialty Chemicals Inc, trade name: TINUVIN329), 2-(2H-benzotriazole-2-yl)-4,6-bis (1-methyl-1-phenylethyl) phenol (Ciba Specialty Chemicals Inc, trade name: TINUVIN234) and the like.

Examples of anilides include 2-ethyl-2′-ethoxy-oxalanilide (Clariant Japan, trade name: SANDEYUBOA VSU) and the like.

Among these UV absorbers, from the viewpoint of the ability to prevent resin degradation due to ultraviolet exposure, benzotriazoles are particularly preferred.

The light stabilizers are compounds which are said to have the function of trapping radicals generated by oxidation mainly due to light. They include for example, hindered amines such as compounds having a 2,2,6,6-tetraalkylpiperidine skeleton and the like.

The mold release agents are compounds having the function of facilitating mold release of the shaped article from the mold. They include for example, higher alcohols such as cetyl alcohol, stearyl alcohol and the like; glycerol higher fatty acid esters such as monoglyceride stearate, diglyceride stearate and the like. Higher alcohols and glycerol fatty acid monoesters are preferably used in combination as mold release agents. When higher alcohols and glycerol fatty acid monoesters are used in combination, the ratio is not particularly limited, but the mass ratio of the higher alcohols/glycerol fatty acid monoesters is preferably from 2.5/1 to 3.5/1 and more preferably from 2.8/1 to 3.2/1.

The polymer processing aids are compounds which are effective for thickness accuracy and thinning when molding the methacrylic resin composition. The polymer processing aids can be usually produced by emulsion polymerization. The polymer processing aids are polymer particles having a particle size of preferably 0.05 to 0.5 μm.

The polymer processing aids may be single-layered particles consisting of a single polymer having a single composition ratio and a single limiting viscosity, or may be multilayered particles consisting of two or more polymers having different composition ratios or different limiting viscosities. Among these, the particles of two-layer structure having a polymer layer with a lower limiting viscosity as an inner layer and a polymer layer with a higher limiting viscosity of 5 dl/g or more as an outer layer may be preferred. The polymer processing aids have preferably a limiting viscosity of 3 to 6 dl/g. A very small limiting viscosity decreases the improving effect of the formability. A very large limiting viscosity tends to lead to a decrease in the melt fluidity of the methacrylic resin composition.

As the impact resistance modifiers, mentioned are core-shell modifiers comprising acrylic rubbers or diene rubbers as a core layer component; modifiers comprising a plurality of rubber particles; and the like.

The compounds having a function of converting ultraviolet rays which is harmful for the resin to visible rays are preferably used as the organic dyes.

As the light diffusion agents and the delusterants, mentioned are glass fine particles, polysiloxane crosslinked fine particles, crosslinked polymer fine particles, talc, calcium carbonate, barium sulfate and the like.

Examples of the fluorescent substances include fluorescent pigments, fluorescent dyes, fluorescent white dyes, fluorescent brightening agents, fluorescent bleaching agents and the like.

The mineral oil softening agents are used to improve the fluidity on molding processing. They include for example, paraffinic oils, naphthenic oils and the like.

As the inorganic fillers, mentioned are calcium carbonate, talc, carbon black, titanium oxide, silica, clay, barium sulfate, magnesium carbonate and the like. As the fibrous fillers, mentioned are glass fiber, carbon fiber and the like.

The methacrylic resin composition of the present invention has the difference between the yellow index (YI4) at an optical path length of 200 mm for an injection molded article obtained at a cylinder temperature of 280° C. and a molding cycle of 4 minutes and the yellow index (YI1) at an optical length of 200 mm for an injection molded article obtained at a cylinder temperature of 280° C. and a molding cycle of 1 minute of not more than 3, preferably not more than 2.5, and more preferably not more than 2. If the difference of the yellow indices is small, it is possible to stably obtain a shaped article having excellent optical properties such as transmittance and color even when injection molding is carried out continuously for a long period of time.

In addition, the yellow index (YI1) at an optical length of 200 mm for an injection molded article obtained at a cylinder temperature of 280° C. and a molding cycle of 1 minute is preferably 10 or less, and more preferably 8 or less. Note that the yellow index is the value of yellowness calculated in accordance with JIS K7373 based on the value measured by using the color-difference colorimeter ZE-2000 manufactured by Nippon Denshoku Industries Co., Ltd., in accordance with JIS Z8722.

Further, the methacrylic resin composition of the present invention has the melt flow rate, at a temperature of 230° C. and under a load of 3.8 kg, of 5 g/10 min or more, preferably 8 to 35 g/10 min and even more preferably 10 to 32 g/10 min. Note that the melt flow rate is the value of the melt mass flow rate measured in accordance with JIS K7210.

Furthermore, the methacrylic resin composition of the present invention, from the viewpoint of suppressing the dimensional change of the shaped article of the present invention obtained therefrom, has the saturated water absorption of preferably 1.6% by mass or less, and more preferably 1.4% by mass or less. Note that the saturated water absorption is the value measured as amass increasing ratio, based on the mass of the shaped article vacuum-dried for 3 days or more, of the mass of the shaped article after being left under a condition at a temperature of 60° C. and a humidity of 90% for 300 hours.

The methacrylic resin composition of the present invention may be used in mixture with other polymers than methacrylic resin, within a range of not compromising the advantages of the present invention. Examples of the other polymers include polyolefin resins such as polyethylene, polypropylene, polybutene-1, poly-4-methylpentene-1, polynorbornene and the like; ethylene ionomers; styrenic resins such as polystyrene, styrene-maleic anhydride copolymer, high impact polystyrenes, AS resins, ABS resins, AES resins, AAS resins, ACS resins, MBS resins; methyl methacrylate-styrene copolymers; polyester resins such as polyethylene terephthalate, polybutylene terephthalate and the like; polyamides such as nylon 6, nylon 66, polyamide elastomers and the like; polycarbonate, polyvinyl chloride, polyvinylidene chloride, polyvinyl alcohol, ethylene-vinyl alcohol copolymer, polyacetal, polyvinylidene fluoride, polyurethanes, modified polyphenylene ether, polyphenylene sulfide, silicone-modified resins; acrylic rubbers, silicone rubbers; styrenic thermoplastic elastomers such as SEPS, SEBS, SIS and the like; olefinic rubbers such as IR, EPR, EPDM and the like.

The methacrylic resin composition of the present invention can be formed by heating and melting with methods such as injection molding (such as insert method, two-color method, pressing method, core back method and sandwich method), compression molding, extrusion molding, vacuum molding, blow molding, inflation molding, calendering to provide various shaped articles. Among those described above, the methacrylic resin composition of the present invention is suitable for producing an injection molded article having a thin wall and large area with small residual strain and little coloration, particularly an injection molded article having a thin wall and large area with a thickness of 1 mm or less and the ratio of the resin flow length to the thickness of 380 or more.

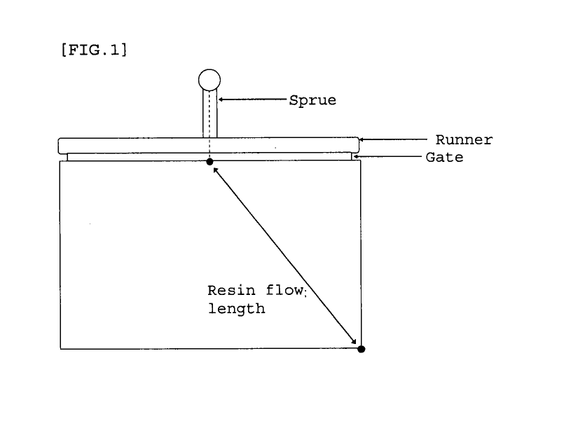

Note that the resin flow length is the distance between the gate of the injection mold and the mold inner wall furthest from the gate. The resin flow length in the film gate is the distance between the foot of the perpendicular drawn from the mounting portion of the sprue of the injection mold to the gate (an intersection with the gate) and the mold inner wall furthest from the intersection (see FIG. 1).

A mold gate to obtain the shaped article according to the present invention is preferably a film gate. The film gate is cut with a cutting machine and subjected to finishing processing with a router and the like. In the mold for obtaining a light guide plate used in a liquid crystal display device, a gate is preferably placed on the end face on which a light source is not intended to be installed.

The applications of the shaped article composed of the methacrylic resin composition of the present invention include for example, signboard components such as advertising towers, stand signboards, side signboards, transom signboards and rooftop signboards; display components such as showcases, partition plates and store displays; lighting components such as fluorescent lamp covers, mood illumination covers, lamp shades, luminous ceilings, light walls and chandeliers; interior components such as pendants and mirrors; building components such as doors, domes, safety window glasses, partitions, stairs wainscots, balcony wainscots and roofs of building for leisure; transport-related components such as aircraft windshields, pilot visors, motorcycles, motorboat windshields, bus light shielding plates, automotive side visors, rear visors, head wing and headlight covers; electronics components such as audio visual tablets, stereo covers, TV protective masks and vending machine display covers; medical equipment components such as incubators and X-ray components; equipment-related components such as machine covers, meter covers, experimental equipment, rulers, dials and observation windows; optical-related components such as liquid crystal protective plates, light guide plates, light guide films, Fresnel lens, lenticular lens, front plates for various displays and diffuser plates; traffic-related components such as road signs, guide plates, curve mirrors and sound barriers; film components such as surface materials for automobile interiors, surface materials for mobile phones and marking films; household electric appliance components such as top cover members and control panels of washing machines and top panels of rice cookers; and also greenhouses, large water tanks, box water tanks, clock panels, bathtubs, sanitary components, desk mats, game components, toys, face protective masks of welding and the like. The shaped article is particularly suitable for applications in a light guide plate having a thin wall and large area, which is produced by injection molding.

### Examples

The present invention will be described in more detail by Examples and Comparative Examples below. Note that the present invention is not intended to be limited by the following Examples.

Measurement of the properties of the methacrylic resin, methacrylic resin compositions and shaped articles obtained in Examples and Comparative Examples was performed according to the following methods.

### (Polymerization Conversion Ratio, Remaining Volatiles)

INERT CAP 1 (df=0.4 μm, 0.25 mm I.D.×60 m) manufactured by GL Sciences Inc. as a column was connected to a gas chromatograph GC-14A manufactured by Shimadzu Corporation, and analysis was performed under the following analytical conditions to calculate therefrom.

### <Analytical Conditions>

Injection temperature: 250° C.
Detector temperature: 250° C.
Column temperature conditions:

Initial temperature: 60° C.

Initial temperature holding time: 5 minutes

Temperature rising rate: 10° C./min

Maximum temperature: 250° C.

Maximum temperature holding time: 10 minutes

### (Weight Average Molecular Weight (Mw) and Molecular Weight Distribution (Mw/Mn))

Weight average molecular weight (Mw) and molecular weight distribution were determined by GPC (gel permeation chromatography) for molecular weight in terms of polystyrene.

Apparatus: GPC apparatus “HLC-8320” manufactured by Tosoh Corporation

Separation column: “TSKguardcolumn SuperHZ-H”, “TSKgel HZM-M” and “TSKgel SuperHZ4000” manufactured by Tosoh Corporation were connected in series.

Eluent: tetrahydrofuran

Eluent flow rate: 0.35 ml/min

Column temperature: 40° C.

Detection method: differential refractive index (RI)

### (Melt Flow Rate)

Melt flow rate was measured at 230° C. under a load of 3.8 kg for 10 minutes in accordance with JIS K7210.

### (Saturated Water Absorption)

The methacrylic resin composition in the pellet form was injection molded using an injection molding machine (Sumitomo Heavy Industries, Ltd., SE-180DU-HP) at a cylinder temperature of 280° C., a mold temperature of 75° C. and a molding cycle of 1 minute to provide a specimen with 100 mm height, 290 mm width and 2 mm thickness. The specimen was vacuum-dried at a temperature of 50° C. and 5 mmHg for 3 days, and the mass of the specimen, W₀, was measured at absolute dry time. Then, the absolute dry specimen was left to stand at a temperature of 60° C. and a humidity of 90% for 300 hours. Subsequently, the mass of the specimen, W₁, was measured. The saturated water absorption (% was calculated based on the following equation.

Saturated water absorption (%)={W₁−W₀}/W₀×100

### (Impact Resistance of Injection-Molded Article)

The methacrylic resin composition in the pellet form obtained from Examples and Comparative Examples was injection molded using an injection molding machine (Sumitomo Heavy Industries, Ltd., SE-180DU-HP) at a cylinder temperature of 230° C., a mold temperature of 65° C. and a molding cycle of 0.5 minutes to prepare a specimen with 80 mm length, 10 mm height and 4 mm width, which was measured for un-notched Charpy impact strength in accordance with ISO179-1eU.

### (Injection Molding Properties)

The appearance of the flat plate S produced in Examples and Comparative Examples was observed with naked eyes. It was evaluated based on the presence/absence of molding defects such as sink marks.

A: No molding defects such as sink marks
B: Existing molding defects such as sink marks

### (Yellow Index)

The yellow index of the monomer mixture used in Examples and Comparative Examples was calculated in accordance with JIS K7373 based on the value measured by using the color-difference colorimeter ZE-2000 manufactured by Nippon Denshoku Industries Co., Ltd., in accordance with JIS Z-8722.

In addition, specimens having 200 mm length were cut from the flat plates L and S prepared in Examples and Comparative Examples respectively, and the yellow indices of the specimens at an optical path length of 200 mm were calculated in accordance with JIS K7373 based on the value measured by using the color-difference colorimeter ZE-2000 manufactured by Nippon Denshoku Industries Co., Ltd., in accordance with JIS Z-8722.

The yellow index of the specimen cut from the flat plate L was YI4 and the yellow index of the specimen cut from the flat plate S was YI1.

### (Light Transmittance)

A Specimen was cut from the flat plate S prepared in Examples and Comparative Examples so that the optical path length would be 200 mm, and the transmittance of the light with a wavelength of 435 nm at an optical path length of 200 mm was measured.

### (Dimensional Change Ratio)

The flat plate S prepared in Examples and Comparative Examples was placed in a thermostatic chamber at 60° C. and left to stand in the atmosphere for 4 hours. The flat plate S was brought out from the thermostatic chamber, and the longitudinal dimension was measured. The dimensional change ratio from the longitudinal dimension (205 mm) before placing the flat plate S in the thermostatic chamber was calculated.

### Example 1

In an autoclave equipped with a stirrer and a sampling tube, charged were 78 parts by mass of purified methyl methacrylate, 20 parts by mass of dicyclopentanyl methacrylate and 2 parts by mass of methyl acrylate to prepare a monomer mixture. The yellow index of the monomer mixture was 0.9. To the monomer mixture, 0.006 part by mass of a polymerization initiator (2,2′-azobis-(2-methylpropionitrile (AIBN), hydrogen abstraction ability: 1%, 1 hour half-life temperature: 83° C.) and 0.37 part by mass of a chain transfer agent (n-octyl mercaptane) were added and to dissolved to obtain raw liquid. Oxygen gas in the producing apparatus was purged by nitrogen gas.

The raw liquid was discharged from the autoclave at a constant rate, fed to a continuous flow tank reactor controlled at a temperature of 140° C. at a constant flow rate so that the average residence time was 120 minutes, and bulk polymerized. The reaction solution sample was collected from the sampling tube of the reactor and measured by gas chromatography to show that the polymerization conversion ratio was 55% by mass.

The solution discharged from the reactor was warmed to 230° C. and fed to a twin screw extruder controlled at 260° C. at a constant flow rate. Volatiles comprising unreacted monomers as a main component were separated and removed in the twin screw extruder, and a resin component was extruded in the strand form. The strand was cut with a pelletizer to provide a methacrylic resin composition in the pellet form. The remaining volatile content was 0.5% by mass.

The polymer properties of the methacrylic resin composition in the pellet form thus obtained were measured.

Shaped articles (flat plates L and S) were prepared from the above methacrylic resin composition in the pellet form using an injection molding machine (Sumitomo Heavy Industries, Ltd., SE-180DU-HP).

The methacrylic resin composition was injection molded at a cylinder temperature of 280° C., a mold temperature of 75° C. and a molding cycle of 4 minutes to produce the flat plate L having 205 mm length, 160 mm width and 0.5 mm thickness. The ratio of the resin flow length (220 mm) to the thickness was 380 or more.

On the other hand, the flat plate S having 205 mm length, 160 mm width and 0.5 mm thickness was produced in the same manner as the process of the flat plate L except that the molding cycle was changed to 1 minute.

The physical properties of the shaped articles thus obtained were evaluated. These results are shown in Table 1.

### Example 2

The methacrylic resin composition of the present invention in the pellet form was produced in the same manner as Example 1 except that the amount of methyl methacrylate was changed to 73 parts by mass, dicyclopentanyl methacrylate was changed to 25 parts by mass and n-octyl mercaptane was changed to 0.35 part by mass. The polymer physical properties of the methacrylic resin composition in the pellet form thus obtained were measured in the same manner as Example 1. In addition, shaped articles (flat plates L and S) were prepared and evaluated for their physical properties in the same manner as Example 1. These results were shown in Table 1.

### Example 3

The methacrylic resin composition of the present invention in the pellet form was produced in the same manner as Example 1 except that the amount of methyl methacrylate was changed to 83 parts by mass, dicyclopentanyl methacrylate was changed to 15 parts by mass and n-octyl mercaptane was changed to 0.32 part by mass. The polymer physical properties of the methacrylic resin composition in the pellet form thus obtained were measured in the same manner as Example 1. In addition, shaped articles (flat plates L and S) were prepared and evaluated for their physical properties in the same manner as Example 1. These results were shown in Table 1.

### Comparative Examples 1 to 4

The methacrylic resin composition in the pellet form was produced in the same manner as Example 1 except for changing the synthetic conditions to those shown in Table 1. The polymer physical properties of these methacrylic resin compositions in the pellet form were measured in the same manner as Example 1. In addition, shaped articles (flat plates L and S) were prepared and evaluated for their properties in the same manner as Example 1. These results were shown in Table 1. Note that due to the poor injection molding of the methacrylic resin composition in the pellet form obtained in Comparative Example 3, the light transmittance and the dimensional change ratio thereof was not measured.

TABLE 1

| | Example | | | Comparative Example | | | |
|---|---|---|---|---|---|---|---|
| | 1 | 2 | 3 | 1 | 2 | 3 | 4 |
| Synthetic Condition | | | | | | | |
| (Monmer Mixture) | | | | | | | |
| Methyl methacrylate | 78 | 73 | 83 | 93 | 43 | 78 | 94 |
| [parts by mass] | | | | | | | |
| TCDMA | 20 | 25 | 15 | 5 | 55 | 20 | — |
| [parts by mass] | | | | | | | |
| Methyl acrylate | 2 | 2 | 2 | 2 | 2 | 2 | 6 |
| [parts by mass] | | | | | | | |
| (Polymerization initiator) | | | | | | | |
| AIBN | 0.006 | 0.006 | 0.006 | 0.007 | 0.006 | 0.006 | 0.075 |
| [part by mass] | | | | | | | |
| (Chain transfer agent) | | | | | | | |
| n-Octyl mercaptane | 0.37 | 0.35 | 0.32 | 0.39 | 0.30 | 0.31 | 0.34 |
| [part by mass] | | | | | | | |
| [Polymerization condition] | | | | | | | |
| Polymerization temperature [° C.] | 140 | 140 | 140 | 140 | 140 | 140 | 140 |
| Average residence time [hr] | 2 | 2 | 2 | 2 | 2 | 2 | 2 |
| Polymerization conversion [%] | 55 | 56 | 56 | 53 | 52 | 55 | 55 |
| Methacrylic resin properties | | | | | | | |
| Weight average molecular | 59 | 60 | 75 | 64 | 60 | 105 | 64 |
| weight (Mw) [×1000] | | | | | | | |
| Molecular weight | 1.8 | 1.8 | 1.8 | 1.8 | 1.8 | 1.8 | 1.8 |
| distribution (Mw/Mn) | | | | | | | |
| Composition properties | | | | | | | |
| Melt flow rate [g/10 min] | 12 | 11 | 6 | 12 | 25 | 3 | 10 |
| Saturated water absorption [mass %] | 1.3 | 1.1 | 1.1 | 1.7 | 0.6 | 1.3 | 1.8 |
| Remaining volatiles [mass %] | 0.5 | 0.5 | 0.5 | 0.5 | 0.5 | 0.5 | 0.5 |
| Molded article properties | | | | | | | |
| Charpy impact strength kJ/m² | 18 | 19 | 19 | 20 | 12 | 19 | 20 |
| Injection moldability | A | A | A | A | A | B | A |
| YI1(molding cycle 60 sec.) | 6.9 | 7.3 | 6.8 | 6.5 | 15.0 | — | 3.5 |
| Difference between YI4 and YI1 | 0.8 | 0.9 | 0.7 | 0.6 | 3.1 | — | 1.9 |
| Light transmittance [%] | 82 | 81 | 83 | 83 | 70 | — | 85 |
| Dimensional change ratio [%] | 0.12 | 0.10 | 0.13 | 0.20 | 0.05 | — | 0.25 |

As shown in Table 1, the methacrylic resin composition of the present invention has excellent injection moldability and enables obtaining a shaped article having a thin wall and large area with good appearance. That is, a shaped article having a thin wall and large area with small residual strain and little coloration can be obtained with high production efficiency by using the methacrylic resin composition of the present invention.

1. A methacrylic resin composition, comprising a methacrylic resin which comprises 50 to 90% by mass of a structural unit derived from methyl methacrylate and 10 to 50% by mass of a structural unit derived from methacrylic acid alicyclic hydrocarbon ester,
wherein the difference between the yellow index (YI4) at an optical path length of 200 mm for an injection molded article obtained at a cylinder temperature of 280° C. and a molding cycle of 4 minutes and the yellow index (YI1) at an optical path length of 200 mm for an injection molded article obtained at a cylinder temperature of 280° C. and a molding cycle of 1 minute is 3 or less, and
the melt flow rate at a temperature of 230° C. and under a load of 3.8 kg is 5 g/10 min or more.

2. The methacrylic resin composition according to claim 1, wherein the methacrylic acid alicyclic hydrocarbon ester is dicyclopentanyl methacrylate.

3. The methacrylic resin composition according to claim 1, wherein the saturated water absorption is 1.6% by mass or less.

4. A method for producing the methacrylic resin composition according to claim 1, the method comprising a step of continuous bulk polymerization of a monomer mixture comprising the methyl methacrylate and the methacrylic acid alicyclic hydrocarbon ester.

5. The method according to claim 4, wherein the methacrylic acid alicyclic hydrocarbon ester is dicyclopentanyl methacrylate.

6. A shaped article comprising the methacrylic resin composition according to claim 1.

7. The shaped article according to claim 6, wherein a ratio of resin flow length to thickness is 380 or more.

8. The shaped article according to claim 6, wherein the methacrylic acid alicyclic hydrocarbon ester is dicyclopentanyl methacrylate.
